(19) United States
(12) Patent Application Publication
(10) Pub. No.: US 2021/0127020 A1
(43) Pub. Date: Apr. 29, 2021

(54) METHOD AND DEVICE FOR PROCESSING IMAGE

(71) Applicant: BEIJING XIAOMI MOBILE SOFTWARE CO., LTD., Beijing (CN)

(72) Inventors: Zongbao YANG, Beijing (CN); Yan ZHENG, Beijing (CN)

(73) Assignee: BEIJING XIAOMI MOBILE SOFTWARE CO., LTD., Beijing (CN)

(21) Appl. No.: 16/831,424

(22) Filed: Mar. 26, 2020

(30) Foreign Application Priority Data
Oct. 23, 2019 (CN) 201911012200.8

(51) Int. Cl. H04N 1/00; H04N 5/232

(52) U.S. Cl. CPC H04N 1/00214; H04N 1/00244; H04N 2201/0084; H04N 5/23229; H04N 1/00251

(57) ABSTRACT

A method of processing an image is applied to a server side and includes: receiving original image data sent by the mobile terminal; processing the original image data to generate processed image data; and sending the processed image data to the mobile terminal. As such, hardware cost of a mobile terminal can be reduced while maintaining image quality.

### CROSS-REFERENCE TO RELATED APPLICATION

This application claims priority to Chinese Patent Application No. 201911012200.8 filed on Oct. 23, 2019, the disclosure of which is hereby incorporated by reference in its entirety.

### BACKGROUND

As consumers' demand on photographing increases, the requirements on the image quality of terminals have become more sophisticated. Under such circumstance, how to balance the hardware cost and the image quality of mobile terminals has become a key issue.

### SUMMARY

The present disclosure relates generally to the technical field of image processing, and more specifically to method and device for processing an image.

Various embodiments of the present disclosure provide method and device for processing an image.

A method for processing an image, applied to a server, includes:

receiving original image data sent by a mobile terminal;

processing the original image data to generate processed image data; and

sending the processed image data to the mobile terminal.

In some embodiments, the original image data have first specified format and are generated by an image sensor of the mobile terminal.

In some embodiments, the receiving the original image data sent by the mobile terminal includes: receiving the original image data via 5G network.

In some embodiments, the processing the original image data includes at least any one of automatic exposure processing, automatic white balance processing, automatic focusing processing, noise reduction processing, and high-dynamic range (HDR) processing on the original image data.

In some embodiments, the processing the original image data to generate the processed image data further includes: processing the original image data to generate the processed image data with second specified format.

In some embodiments, the sending the processed image data to the mobile terminal includes: sending the processed image data to the mobile terminal via 5G network.

Some embodiments of the present disclosure provide a method for processing an image, characterized in that the method is applied to a mobile terminal and includes:

acquiring original image data;

sending the original image data to a server such that the server can process the original image data to generate processed image data; and

receiving the processed image data sent by the server

In some embodiments, the mobile terminal includes an image sensor; and

the acquiring the original image data includes: acquiring the original image data with first specified format generated by the image sensor.

In some embodiments, the sending the original image data to the server includes: sending the original image data to the server via 5G network.

In some embodiments, the receiving the processed image data sent by the server includes: receiving the processed image data sent by the server via 5G network.

In some embodiments, the processed image data have second specified format.

Some embodiments of the present disclosure provide a device for processing an image, applied to a server and includes:

a processor; and

memory storing instructions for execution by the processor to receive original image data sent by a mobile terminal, process the original image data to generate processed image data and send the processed image data to the mobile terminal.

In some embodiments, the original image data have first specified format and are generated by an image sensor of the mobile terminal.

In some embodiments, the processor is further configured to receive the original image data via a 5G network.

In some embodiments, the processor includes at least one of the following:

an automatic exposure processing unit, an automatic white balance processing unit, an automatic focusing processing unit, a noise reduction processing unit, or an HDR processing unit.

In some embodiments, the processor further includes: a processing unit configured to process the original image data to generate the processed image data with second specified format.

In some embodiments, the processor is further configured to send the processed image data to the mobile terminal via a 5G network.

Some embodiments of the present disclosure provide a mobile terminal includes:

a processing circuit; and

memory storing instructions for execution by the processing circuit to implement operations of the above method;

In some embodiments, the mobile terminal includes an image sensor; and the processing circuit is configured to acquire the original image data with first specified format generated by an image sensor.

In some embodiments, the processing circuit is further configured to send the original image data to the server via a 5G network and receive the processed image data sent by the server via 5G network; and the processed image data have second specified format.

Some embodiments of the present disclosure provide an image processing system implementing the above method, comprises the server, wherein the processing by the server comprises at least one of automatic exposure processing, automatic white balance processing, automatic focusing processing, noise reduction processing, and high-dynamic range (HDR) processing.

In some embodiments, the image processing system further comprises a plurality of mobile terminals including the mobile terminal, wherein the mobile terminal comprises an image sensor configured to acquire the original image data with a first specified format of MIPI10bit RAW; and wherein the mobile terminal is configured to send the original image data to the server via a 5G network to facilitate the server processing the original image data to generate the processed image data and receive the processed image data having a second specified format of at least one of digital negative (DNG), bitmap (BMP), portable network graphics (PNG), and joint photographic expert group (JPEG), sent by the server via the 5G network.

### BRIEF DESCRIPTION OF THE DRAWINGS

The accompanying drawings, which are incorporated in and constitute a part of this disclosure, illustrate embodiments consistent with the disclosure and, together with the disclosure, serve to explain the principles of the disclosure.

FIG. 1 is a flowchart illustrating a method for processing an image in accordance with some embodiments.

FIG. 2 is a flowchart illustrating a method for processing an image in accordance with another exemplary embodiment.

FIG. 3 is a structural block diagram illustrating a device for processing an image in accordance with some embodiments.

FIG. 4 is a structural block diagram of a processing module in the device for processing an image in accordance with some embodiments.

FIG. 5 is a structural block diagram of a processing module in the device for processing an image in accordance with another exemplary embodiment.

FIG. 6 is a structural block diagram illustrating a device for processing an image in accordance with another exemplary embodiment.

FIG. 7 is a structural block diagram of a mobile terminal in accordance with some embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of devices and methods consistent with aspects related to the disclosure as recited in the appended claims.

The terms used in the present disclosure are for the purpose of describing particular embodiments only and are not intended to limit the present disclosure. Unless otherwise defined, the technical or scientific terms used in the present disclosure shall have the ordinary meanings understood by those skilled in the art. The words “a” or “an” and the like used in the present disclosure and the appended claims do not indicate a limitation on quantity, but rather indicate that there is at least one. Unless otherwise specified, “comprise”/“comprising” or “include”/“including” and similar words mean that the element or object appearing before “comprising” or “including” encompasses the elements or objects appearing after “including” or “including” and the equivalent thereof, and does not exclude other elements or objects. Words such as “connect” or “connected” are not limited to physical or mechanical connections, and may include electrical connections, whether direct or indirect.

The singular forms “a/an,” “the” and “said” used in this application and the attached claims are intended to include the plural forms, unless the context clearly indicates otherwise. It should be understood that the term “and/or” used herein refers to and comprises any or all possible combinations of one or more of the associated listed items.

In some embodiments, the mobile terminal includes a camera module, a processor and a display. The camera module is configured to acquire original image data of an image. The processor is configured to receive the original image data generated by the camera module and process the original image data. Moreover, the processor further controls the display to display the image according to processed image data.

In this way, the following solutions may be adopted in the process of optimizing the image quality of the mobile terminal:

First solution: adopting a processor with better image processing performance to optimize the image quality of the mobile terminal. However, the processor with better performance has high cost and is difficult to adapt to mobile terminals of various price grades.

Second solution: optimizing lines for connecting the camera module and the processor according to the generative capacity of the camera module, so as to improve the integrity of signals generated by the camera module and improve the image quality. However, this solution increases the difficulty of wiring on a circuit board and increases the installation and maintenance costs of the lines.

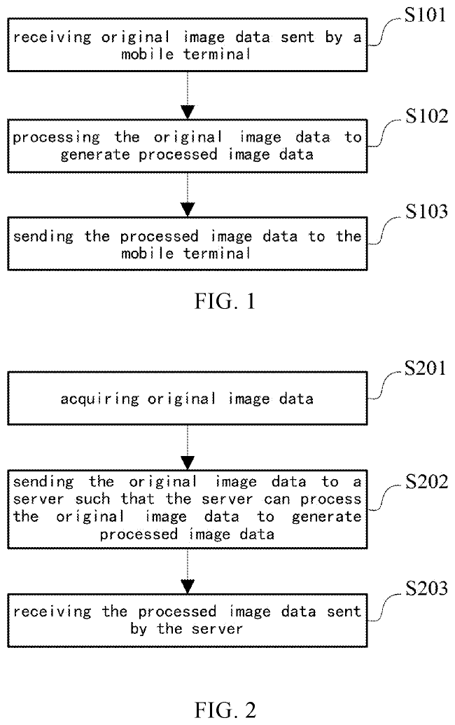

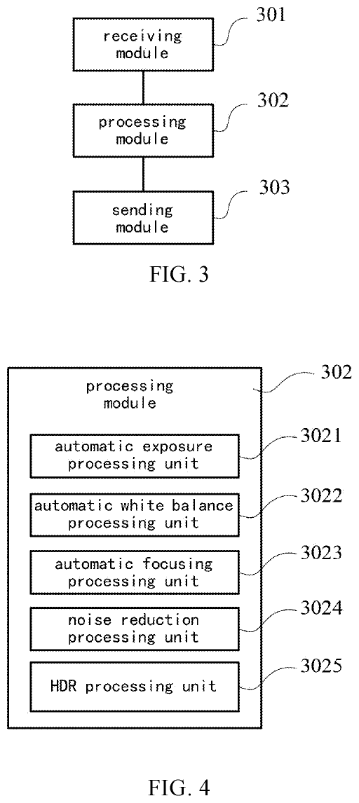

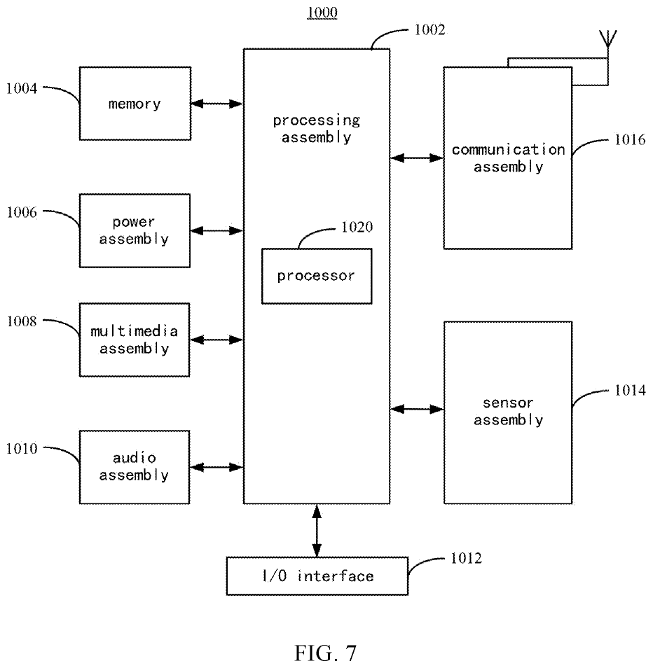

In summary, it is difficult to have both high image quality and low equipment cost for the mobile terminal. In view of this, the present disclosure provides embodiments of method and device for processing an image. FIGS. 1 and 2 are flowcharts of a method for processing an image in accordance with various exemplary embodiments. FIGS. 3 to 6 are structural block diagrams of a device for processing an image in accordance with various exemplary embodiments. FIG. 7 is a structural block diagram of a mobile terminal in accordance with some embodiments.

In some embodiments, there is provided a method for processing an image which is applied to a server side. Referring to FIG. 1, the method specifically includes:

S101: receiving original image data sent by a mobile terminal.

The original image data are directly generated by an image sensor in the mobile terminal according to optical signals and are not processed. Wherein, the original image data include image data of a one-frame or multi-frame (e.g., 2-frame, 4-frame, 6-frame, 8-frame, or 10-frame) image. Optionally, the image data of the multi-frame image are generated by the image sensor of the mobile terminal in response to one image capturing trigger operation. Accordingly, the server can perform integration of the original image data of the multi-frame image to optimize the processing effect.

Moreover, in the step S101, the original image data have first specified format such as MIPI10bit RAW. In this way, the original image data received by the server are in unified format to facilitate the subsequent processing of the original image data.

In one example, the step S101 specifically includes: receiving the original image data via 5G network. Based on the high transmission speed of the 5G network, the original image data transmitted through the 5G network guarantees the timeliness and workflow of the overall processing procedure, and optimizes the user experience. Of course, alternatively, the original image data may be received by other network communication technologies in the step S101.

S102: processing the original image data to generate processed image data.

The server includes a processing assembly for processing the image data, such as a processing chip. In the step S102, the processing the original image data by the server includes at least one of automatic exposure processing, automatic white balance processing, automatic focusing processing, noise reduction processing, and HDR processing. If the processing in the step S202 includes HDR processing, the original image data include original image data of a multi-frame image.

The image quality of the processed image data generated in the step S102 is superior to the image quality of the original image data, so as to satisfy the user demands.

By adoption of this method, the processing procedure of the original image data is performed at the server side. Thus, it is required to optimize the hardware performances of the server for improving the image quality. Then, the mobile terminal adapting to the server can realize the method for processing the image. In this way, the requirement of the mobile terminal on an image processor is reduced and even it can be realized that image processing is be not performed at the mobile terminal side, but completely executed by the server. This method obviously reduces the hardware cost of the mobile terminal. Moreover, the entire image processing procedure is executed by the server, and the improvement of the image quality may not by optimizing the wiring or lines of the camera module and the processor.

In addition, in the step S101, the original image data are all in first specified format. In this case, when adapting to different mobile terminals, the server always receives the original image data in the same format, which improves the compatibility between the server and the mobile terminals with different price grades, different brands, and different models. Moreover, the server can directly process the data after receiving the original image data, thereby improving the processing efficiency and guaranteeing the processing quality.

Moreover, in one example, the step S102 further includes: processing the original image data to generate processed image data with second specified format. Herein, the second specified format may select any one of digital negative (DNG) format, bitmap (BMP) format, portable network graphics (PNG) format, joint photographic expert group (JPEG) format, and the like.

In this way, the server outputs the processed image data in the same format, thereby facilitating the mobile terminal to receive the processed image data for subsequent operations, and improving the compatibility between the server and various mobile terminals.

S103: sending the processed image data to the mobile terminal.

In one example, the step S103 specifically includes: sending the processed image data to the mobile terminal via 5G network. In combination with the step S101, the server and the mobile terminal realize information transmission via the 5G network. This means fully utilizes the transmission capability of the 5G network to ensure the smoothness and timeliness of the image processing procedure and optimizes the user experience. Of course, the server may adopt other network communication technologies to send the processed image data.

An image processing system implementing the above method, comprises the server, wherein the processing by the server comprises at least one of automatic exposure processing, automatic white balance processing, automatic focusing processing, noise reduction processing, and high-dynamic range (HDR) processing.

In one example, the image processing system further comprises a plurality of mobile terminals including the mobile terminal, wherein the mobile terminal comprises an image sensor configured to acquire the original image data with a first specified format of MIPI10bit RAW; and wherein the mobile terminal is configured to send the original image data to the server via a 5G network to facilitate the server processing the original image data to generate the processed image data and receive the processed image data having a second specified format of at least one of digital negative (DNG), bitmap (BMP), portable network graphics (PNG), and joint photographic expert group (JPEG), sent by the server via the 5G network.

the method for processing the image according to some embodiments is applied to the mobile terminal side. The mobile terminal includes a camera module, a processor and a display.

The camera module includes a lens and an image sensor. Light is transmitted through the lens and projected onto the image sensor, and the image sensor converts received optical signals into electrical signals so that the original image data is generated. Herein, the specific types of the lens and the image sensor are not limited. For instance, the lens may be selected from a wide-angle lens, a telephoto lens, a fisheye lens, or a macro lens, and the image sensor may be selected from a charge-coupled device (CCD) or a complementary metal oxide semiconductor (CMOS) device. The processor controls a display to display an image according to the processed image data.

Referring to FIG. 2, the method for processing the image provided by the embodiments of the present disclosure specifically includes:

S201: acquiring original image data.

The original image data are directly generated by an image sensor in a mobile terminal according to optical signals. In one example, the step S201 includes: acquiring the original image data with first specified format generated by the image sensor. The original image data generated by the image sensor are data not processed.

In one example, the original image data include image data of a one-frame or multi-frame (e.g., 2 frame, 4 frame, 6 frame, 8 frame or 10 frame) image. Optionally, the image data of the multi-frame image are generated by the image sensor of the mobile terminal in response to one image capturing trigger operation. By this means, the server can integrate the original image data of the multi-frame image to optimize the processing effect.

Moreover, the original image data have first specified format such as MIPI10bit RAW. By this means, the mobile terminal outputs the original image data in unified format, such that various mobile terminals can adapt to the server, thereby improving the compatibility and the consistency of data processing.

S202: sending the original image data to the server such that the server can process the original image data to generate processed image data.

In combination with the workflow of the server side, the server is adopted to perform one or more of automatic exposure processing, automatic white balance processing, automatic focusing processing, noise reduction processing, and HDR processing on the original image data.

In this way, the image processing procedure is performed at the server side, thereby reducing the requirement on the image processing capacity of the processor of the mobile terminal, further reducing the hardware cost of the processor in the mobile terminal and/or the wiring of a circuit board. Moreover, this means is applicable to mobile terminals with various price grades, brands and models, so the mobile device with low cost can also reveal high-quality images to meet user needs.

In one example, the step S202 specifically includes: sending the original image data to the server via 5G network.

Moreover, after the step S202, the method further includes:

S203: receiving the processed image data sent by the server. In one example, the step S203 specifically includes: receiving the processed image data sent by the server via 5G network.

In this way, the mobile terminal performs data transmission with the server through the 5G network. Based on the ultra-high-speed data transmission capability of the 5G network, the mobile terminal uploads the original image data and receives the processed image data almost in real time. Moreover, for users of the mobile terminal, the overall image processing procedure shows good timeliness and fluency.

In such a case, the mobile terminal is equipped with a 5G module to send and receive data through the 5G network. Of course, alternatively, the mobile terminal may perform data transmission with the server through other wireless communication technologies, such as higher-level communication technologies such as 6G, which is not specifically limited in this disclosure.

As for the step S203, it should be also noted that the processed image data are in second specified format such as DNG format, BMP format, PNG format or JPEG format. In this way, the format of the processed image data received by the mobile terminal is unified, and after the mobile terminal receives the processed image data, the image can be displayed according to the processed image data, thereby optimizing the consistency and compatibility of the mobile terminal and the server during image processing.

Based on the above method for processing the image at the server side and the terminal side, in some embodiments, the overall interactive process of the method for processing the image according to the embodiments in the present disclosure is as follows:

The mobile terminal acquires the original image data in response to one image capturing trigger operation. After acquiring the original image data, the mobile terminal sends the original image data to the server. The server receives the original image data and performs focusing processing, white balance processing, noise reduction processing and rendering processing and the like to generate the processed image data. Subsequently, the server sends the processed image data to the mobile terminal. The mobile terminal receives the processed image data and performs subsequent operation accordingly, such as displaying an image on a display.

the method for processing the image according to the embodiments in the present disclosure perform image processing at the server side, thereby reducing the requirement at the mobile terminal side on the image processing capacity of the processor, and further reducing the hardware cost of the mobile terminal and the debugging and maintenance costs of the mobile terminal. In addition, the method according to the embodiments of the present disclosure has high universality and can be applied to mobile terminals with various models, prices and brands.

Based on the above method, various embodiments of the present disclosure provide a device for processing an image correspondingly. In some embodiments, referring to FIG. 3, the device for processing the image is applied to a server and includes: a processor; and memory storing instructions for execution by the processor to receive original image data sent by a mobile terminal, process the original image data to generate processed image data and send the processed image data to the mobile terminal.

In one example, a receiving module 301 configured to receive original image data sent by a mobile terminal;

In one example, a processing module 302 configured to process the original image data to generate processed image data; and

In one example, a sending module 303 configured to send the processed image data to the mobile terminal.

In one example, the original image data have first specified format and are generated by an image sensor of the mobile terminal.

In one example, the processor is further configured to receive the original image data via a 5G network.

In one example, referring to FIG. 4, the processing module 302 at least includes one of an automatic exposure processing unit 3021, an automatic white balance processing unit 3022, an automatic focusing processing unit 3023, a noise reduction processing unit 3024 and an HDR processing unit 3025.

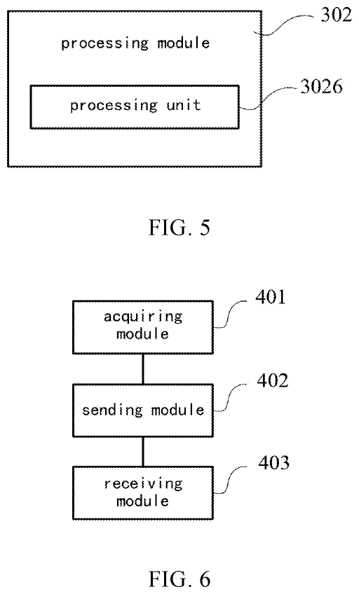

In one example, referring to FIG. 5, the processing module 302 further includes a processing unit 3026 which is configured to process the original image data to generate the processed image data with second specified format.

In one example, the processor is further configured to send the processed image data to the mobile terminal via a 5G network.

In one example, referring to FIG. 6, the device for processing the image, i.e. the mobile terminal includes: a processing unit; and a memory storing instructions for execution by the processing unit to implement operations of the above method:

In one example, an acquiring module 401 (processing circuit) of the mobile terminal configured to acquire original image data;

In one example, a sending module 402 of the mobile terminal configured to send the original image data to a server, such that the server can process the original image data to generate processed image data; and

In one example, a receiving module 403 of the mobile terminal configured to receive the processed image data sent by the server.

In one example, the mobile terminal includes an image sensor, and the processing circuit is configured to acquire the original image data with first specific format generated by the image sensor.

The mobile terminal is further configured to send the original image data to the server via a 5G network, and receive the processed image data sent by the server via the 5G network; and the processed image data have second specified format.

In one example, the sending module 402 of the mobile terminal is further configured to send the original image data to the server via a 5G network.

In one example, the receiving module 403 of the mobile terminal is further configured to receive the processed image data sent by the server via 5G network.

Referring to FIG. 7, the mobile terminal 1000 may comprise one or more of a processing assembly 1002, a memory 1004, a power assembly 1006, a multi-media assembly 1008, an audio assembly 1010, an input/output (I/O) interface 1012, a sensor assembly 1014 and a communication assembly 1016.

The processing assembly 1002 typically controls overall operations of the mobile terminal 1000, such as the operations associated with display, telephone calls, data communications, camera operations, and recording operations. The processing assembly 1002 may include one or more processors 1020 to execute instructions to perform all or part of the steps in the above described methods. Moreover, the processing assembly 1002 may include one or more modules which facilitate the interaction between the processing assembly 1002 and other assemblies. For instance, the processing assembly 1002 may include a multimedia module to facilitate the interaction between the multimedia assembly 1008 and the processing assembly 1002.

The memory 1004 is configured to store various types of data to support the operation of the mobile terminal 1000. Examples of such data include instructions for any applications or methods operated on the mobile terminal 1000, contact data, phonebook data, messages, pictures, video, etc. The memory 1004 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power assembly 1006 provides power to various assemblies of the mobile terminal 1000. The power assembly 1006 may include a power management system, one or more power sources, and any other assemblies associated with the generation, management, and distribution of power in the mobile terminal 1000.

The multimedia assembly 1008 includes a screen providing an output interface between the mobile terminal 1000 and the user. In some embodiments, the screen may include a liquid crystal display (LCD) and a touch panel (TP). In some embodiments, the screen may include an organic light-emitting diode (OLED) display or other types of displays.

If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and pressure associated with the touch or swipe action. In some embodiments, the multimedia assembly 1008 includes a front camera and/or a rear camera. The front camera and the rear camera may receive external multimedia data while the mobile terminal 1000 is in an operation mode, such as a photographing mode or a video mode. Each of the front camera and the rear camera may be a fixed optical lens system or have focus and optical zoom capability.

The audio assembly 1010 is configured to output and/or input audio signals. For example, the audio assembly 1010 includes a microphone (“MIC”) configured to receive an external audio signal when the mobile terminal 1000 is in an operation mode, such as a call mode, a recording mode, and a voice recognition mode. The received audio signal may be further stored in the memory 1004 or transmitted via the communication assembly 1016. In some embodiments, the audio assembly 1010 further includes a speaker to output audio signals.

The I/O interface 1012 provides an interface between the processing assembly 1002 and peripheral interface modules, such as a keyboard, a click wheel, buttons, and the like. The buttons may include, but are not limited to, a home button, a volume button, a starting button, and a locking button.

The sensor assembly 1014 includes one or more sensors to provide status assessments of various aspects of the mobile terminal 1000. For instance, the sensor assembly 1014 may detect an open/closed status of the mobile terminal 1000, relative positioning of assemblies, e.g., the display and the keypad, of the mobile terminal 1000, a change in position of the mobile terminal 1000 or a assembly of the mobile terminal 1000, a presence or absence of user contact with the mobile terminal 1000, an orientation or an acceleration/deceleration of the mobile terminal 1000, and a change in temperature of the mobile terminal 1000. The sensor assembly 1014 may include a proximity sensor configured to detect the presence of nearby objects without any physical contact. The sensor assembly 1014 may also include a light sensor, such as a CMOS or CCD image sensor, for use in imaging applications. In some embodiments, the sensor assembly 1014 may also include an accelerometer sensor, a gyroscope sensor, a magnetic sensor, a pressure sensor, or a temperature sensor.

The communication assembly 1016 is configured to facilitate communication, wired or wirelessly, between the mobile terminal 1000 and other devices. The mobile terminal 1000 can access a wireless network based on a communication standard, such as Wi-Fi, 2G, 3G, 4G, 5G, or a combination thereof. In one exemplary embodiment, the communication assembly 1016 receives a broadcast signal or broadcast associated information from an external broadcast management system via a broadcast channel. In one exemplary embodiment, the communication assembly 1016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the mobile terminal 1000 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic assemblies, for performing the above described methods.

In exemplary embodiments, there is also provided a non-transitory computer-readable storage medium including instructions, such as included in the memory 1004, executable by the processor 1020 in the mobile terminal 1000, for performing the above methods. For example, the non-transitory computer-readable storage medium may be a ROM, a random-access memory (RAM), a CD-ROM, a magnetic tape, a floppy disc, an optical data storage device, and the like.

Various embodiments of the present disclosure can have one or more the following advantages.

Image processing can be performed at the server side, thereby reducing the image processing requirement on the mobile terminal, and reducing the hardware cost and the maintenance cost of the mobile terminal while maintaining the image quality.

The various device components, modules, units, blocks, or portions may have modular configurations, or are composed of discrete components, but nonetheless can be referred to as “modules” in general. In other words, the “components,” “modules,” “blocks,” “portions,” or “units” referred to herein may or may not be in modular forms.

Other implementation solutions of the present disclosure will be apparent to those skilled in the art from consideration of the specification and practice of the embodiments of the present disclosure. This disclosure is intended to cover any variations, uses, or adaptations of the embodiments of the present disclosure following the general principles thereof and including such departures from the embodiments of the present disclosure as come within known or customary practice in the art. It is intended that the specification and examples be considered as exemplary only, with a true scope and spirit of the embodiments of the present disclosure being indicated by the following claims.

In the embodiments of the present disclosure, the feed object of each feed port is changed through a shift function of the radio frequency switch, thereby forming different antenna arrays in different states and extending coverage of the antenna array. Compared with the technical solution that each antenna array includes fixed array elements in the related art, an arraying manner for the antenna array in the embodiment of the present disclosure is more flexible.

In the present disclosure, the terms “installed,” “connected,” “coupled,” “fixed” and the like shall be understood broadly, and can be either a fixed connection or a detachable connection, or integrated, unless otherwise explicitly defined. These terms can refer to mechanical or electrical connections, or both. Such connections can be direct connections or indirect connections through an intermediate medium. These terms can also refer to the internal connections or the interactions between elements. The specific meanings of the above terms in the present disclosure can be understood by those of ordinary skill in the art on a case-by-case basis.

In the description of the present disclosure, the terms “one embodiment,” “some embodiments,” “example,” “specific example,” or “some examples,” and the like can indicate a specific feature described in connection with the embodiment or example, a structure, a material or feature included in at least one embodiment or example. In the present disclosure, the schematic representation of the above terms is not necessarily directed to the same embodiment or example.

Moreover, the particular features, structures, materials, or characteristics described can be combined in a suitable manner in any one or more embodiments or examples. In addition, various embodiments or examples described in the specification, as well as features of various embodiments or examples, can be combined and reorganized.

In some embodiments, the control and/or interface software or app can be provided in a form of a non-transitory computer-readable storage medium having instructions stored thereon is further provided. For example, the non-transitory computer-readable storage medium can be a magnetic tape, a floppy disk, optical data storage equipment, a flash drive such as a USB drive or an SD card, and the like.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more portions of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium can be tangible.

The operations described in this disclosure can be implemented as operations performed by a data processing apparatus on data stored on one or more computer-readable storage devices or received from other sources.

The devices in this disclosure can include special purpose logic circuitry, e.g., an FPGA (field-programmable gate array), or an ASIC (application-specific integrated circuit). The device can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The devices and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and it can be deployed in any form, including as a stand-alone program or as a portion, component, subroutine, object, or other portion suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more portions, sub-programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA, or an ASIC.

Processors or processing circuits suitable for the execution of a computer program include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented with a computer and/or a display device, e.g., a VR/AR device, a head-mount display (HMD) device, a head-up display (HUD) device, smart eyewear (e.g., glasses), a CRT (cathode-ray tube), LCD (liquid-crystal display), OLED (organic light emitting diode), or any other monitor for displaying information to the user and a keyboard, a pointing device, e.g., a mouse, trackball, etc., or a touch screen, touch pad, etc., by which the user can provide input to the computer.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components.

The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any claims, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination.

Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

As such, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing can be utilized.

It is intended that the specification and embodiments be considered as examples only. Other embodiments of the disclosure will be apparent to those skilled in the art in view of the specification and drawings of the present disclosure. That is, although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the example embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

It should be understood that “a plurality” or “multiple” as referred to herein means two or more. “And/or,” describing the association relationship of the associated objects, indicates that there may be three relationships, for example, A and/or B may indicate that there are three cases where A exists separately, A and B exist at the same time, and B exists separately. The character “/” generally indicates that the contextual objects are in an “or” relationship.

In the present disclosure, it is to be understood that the terms “lower,” “upper,” “under” or “beneath” or “underneath,” “above,” “front,” “back,” “left,” “right,” “top,” “bottom,” “inner,” “outer,” “horizontal,” “vertical,” and other orientation or positional relationships are based on example orientations illustrated in the drawings, and are merely for the convenience of the description of some embodiments, rather than indicating or implying the device or component being constructed and operated in a particular orientation. Therefore, these terms are not to be construed as limiting the scope of the present disclosure.

In the present disclosure, a first element being “on” a second element may indicate direct contact between the first and second elements, without contact, or indirect geometrical relationship through one or more intermediate media or layers, unless otherwise explicitly stated and defined. Similarly, a first element being “under,” “underneath” or “beneath” a second element may indicate direct contact between the first and second elements, without contact, or indirect geometrical relationship through one or more intermediate media or layers, unless otherwise explicitly stated and defined.

In the description of the present disclosure, the terms “some embodiments,” “example,” or “some examples,” and the like may indicate a specific feature described in connection with the embodiment or example, a structure, a material or feature included in at least one embodiment or example. In the present disclosure, the schematic representation of the above terms is not necessarily directed to the same embodiment or example.

Moreover, the particular features, structures, materials, or characteristics described may be combined in a suitable manner in any one or more embodiments or examples. In addition, various embodiments or examples described in the specification, as well as features of various embodiments or examples, may be combined and reorganized.

While this specification contains many specific implementation details, these should not be construed as limitations on the scope of any claims, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable sub combinations.

Moreover, although features can be described above as acting in certain combinations and even initially claimed as such, one or more features from a claimed combination can in some cases be excised from the combination, and the claimed combination can be directed to a subcombination or variations of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

As such, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing can be utilized.

Some other embodiments of the present disclosure can be available to those skilled in the art upon consideration of the specification and practice of the various embodiments disclosed herein. The present application is intended to cover any variations, uses, or adaptations of the present disclosure following general principles of the present disclosure and include the common general knowledge or conventional technical means in the art without departing from the present disclosure. The specification and examples can be shown as illustrative only, and the true scope and spirit of the disclosure are indicated by the following claims.

1. A method for processing an image, applied to a server and comprises:
receiving original image data sent by a mobile terminal;
processing the original image data to generate processed image data; and
sending the processed image data to the mobile terminal.

2. The method according to claim 1, wherein the original image data have first specified format and are generated by an image sensor of the mobile terminal.

3. The method according to claim 1, wherein the receiving the original image data sent by the mobile terminal comprises: receiving the original image data via 5G network.

4. The method according to claim 1, wherein the processing the original image data comprises at least one of automatic exposure processing, automatic white balance processing, automatic focusing processing, noise reduction processing, and high-dynamic range (HDR) processing on the original image data.

5. The method according to claim 4, wherein the processing the original image data to generate the processed image data further comprises:
processing the original image data to generate the processed image data with second specified format.

6. The method according to claim 1, wherein the sending the processed image data to the mobile terminal comprises:
sending the processed image data to the mobile terminal via 5G network.

7. A method for processing an image, applied to a mobile terminal and comprises:
acquiring original image data;
sending the original image data to a server to facilitate the server processing the original image data to generate processed image data; and
receiving the processed image data sent by the server.

8. The method according to claim 7, wherein the mobile terminal comprises an image sensor; and the acquiring the original image data comprises:
acquiring the original image data with first specified format generated by the image sensor.

9. The method according to claim 7, wherein the sending the original image data to the server comprises:
sending the original image data to the server via 5G network.

10. The method according to claim 7, wherein the receiving the processed image data sent by the server comprises:
receiving the processed image data sent by the server via 5G network.

11. The method according to claim 7, wherein the processed image data have second specified format.

12. A device for processing an image, applied to a server and comprises:
a processor; and
memory storing instructions for execution by the processor to:
receive original image data sent by a mobile terminal;
process the original image data to generate processed image data; and
send the processed image data to the mobile terminal.

13. The device according to claim 12, wherein the original image data have first specified format and are generated by an image sensor of the mobile terminal.

14. The device according to claim 12, wherein the processor is further configured to receive the original image data via a 5G network.

15. The device according to claim 12, wherein the processor is further configured to send the processed image data to the mobile terminal via a 5G network.

16. A mobile terminal implementing the method according to claim 7, comprising:
a processing circuit; and
memory storing instructions for execution by the processing circuit to implement operations of the method.

17. The mobile terminal according to claim 16, wherein the mobile terminal comprises an image sensor; and the processing circuit is configured to acquire the original image data with first specified format generated by an image sensor.

18. The mobile terminal according to claim 16, wherein the mobile terminal is further configured to send the original image data to the server via a 5G network, and receive the processed image data sent by the server via the 5G network; and the processed image data have second specified format.

19. An image processing system implementing the method of claim 1, comprising the server, wherein the processing by the server comprises at least one of automatic exposure processing, automatic white balance processing, automatic focusing processing, noise reduction processing, and high-dynamic range (HDR) processing.

20. The image processing system of claim 19, further comprising a plurality of mobile terminals including the mobile terminal, wherein the mobile terminal comprises an image sensor configured to acquire the original image data with a first specified format of MIPI10bit RAW; and wherein the mobile terminal is configured to:
send the original image data to the server via a 5G network to facilitate the server processing the original image data to generate the processed image data; and
receive the processed image data having a second specified format of at least one of digital negative (DNG), bitmap (BMP), portable network graphics (PNG), and joint photographic expert group (JPEG), sent by the server via the 5G network.
